(19) United States
(12) Patent Application Publication
(10) Pub. No.: US 2007/0193426 A1
(43) Pub. Date: Aug. 23, 2007

(54) Adhesive tape dispenser

(76) Inventor: Sang Chul Lee, Gwangmyeong-si (KR)

Correspondence Address: KIRTON AND MCCONKIE, 60 EAST SOUTH TEMPLE,, SUITE 1800, SALT LAKE CITY, UT, 84111, US

(21) Appl. No.: 10/599,011

(22) PCT Filed: Apr. 29, 2005
(86) PCT No.: PCT/KR05/01248

§ 371 Date: Sep. 18, 2006

(30) Foreign Application Priority Data
Apr. 30, 2004 (KR) 2004-0030743

(51) Int. Cl. B65H 35/07; B26D 5/22

(52) U.S. Cl. 83/205; 83/436.5; 83/436.8

(57) ABSTRACT

The present invention relates to an adhesive tape dispenser which includes a drawing trigger and a cutting lever close to each other to be pulled by a user's finger and contains an adhesive tape with various width therein, so that the convenience of users can greatly be enhanced and the efficiency in using an adhesive tape can be improved. The adhesive tape dispenser comprises a case body; a drawing means including a trigger protruded out of the case body and a pair of drums rotated by pulling the trigger; a cutting means including a cutting lever provided adjacent to the trigger outside of the case body, a lever operated by pulling the cutting lever, and a cutter; and a reverse control means to prevent a backlash of the drums in operating the drawing means.

### TECHNICAL FIELD

The present invention relates to an adhesive tape dispenser, and more particularly to a tape dispenser including a drawing trigger and a cutting lever close to each other to be pulled by a user's finger and containing an adhesive tape with various width therein, so that the convenience of users can greatly be enhanced and the efficiency in using an adhesive tape can be improved.

### BACKGROUND ART

Generally, a tape lined with an adhesive on one side or both sides is used to stick papers or other articles together. It is wound on a roll and is received in a case. The case for the adhesive tape is usually made of transparent synthetic resin material such as acryl, so that a user can see the adhesive tape therein at any time.

A conventional case for the adhesive tape was formed in a rounded barrel type having an opening on one side, and it had a cylindrical axis in the center thereof, so that the adhesive tape wound on the roll could fit onto the cylindrical axis and rotate freely centering around the axis. The opening of the case was usually covered with a paper cap.

The adhesive tape case had an outlet at one end, through which a front end of the tape could be drawn out. At the outlet, a securing part was provided to have the front end of the tape attached thereto. In front of the securing part, a cutting means having a plurality of sharp teeth was provided in a line. When the adhesive tape received in such a conventional tape case was to be used, a user first had to grasp the front end of the adhesive tape with one hand. Then, the user had to detach it from the securing part and pull it as long as necessary until a predetermined length of adhesive tape was withdrawn and cut by the cutting means. All these procedures had to be taken manually and it was not convenient. Also, it was not sanitary to grasp and detach the adhesive tape with fingers of the user.

In order to increase the convenience of users, the inventor of the present invention suggested an adhesive tape dispenser in Korean Patent Application No. 1999-35136 and Patent No. 355548. The adhesive tape dispenser had an automatic drawing means, which could be used like a trigger of a gun without touching one's finger on the adhesive tape. Also, it had a cutting means, which could be used by merely pushing an operating button and could cut the tape clean. Specifically, the adhesive tape dispenser by the inventor comprised a gun-shaped case body; a detachable cover; a drawing means having a trigger protruded from a part of the case body and a pair of drums rotating in line with the trigger; and a cutting means including an operating button mounted on a surface of the case body, a lever working in association with the operating button, and a cutter provided at a front end of the lever.

With the above adhesive tape dispenser, by putting one's finger on the trigger and pulling the trigger once or several times, the adhesive tape could be drawn from the case body as long as necessary without touching and pulling the adhesive tape with one's hand.

Further, by pulling the operating button on the surface of the case body, the adhesive tape with a desired length could be cut clean.

### DISCLOSURE OF INVENTION

Technical Problem

However, since the above conventional adhesive tape dispenser was designed to receive the adhesive tape with a narrow width, e.g., about 10 mm, the case body and the drums were also designed to have a relatively narrow width.

Also, other parts of the tape dispenser constituting the drawing means and the cutting means had to be designed to be small enough to be received in the case body and to operate precisely.

Therefore, since the small parts of the tape dispenser should be precisely arranged in the case body, specifically in the drums, it was not efficient to assembly them.

In addition, in the above conventional tape dispenser, since the operating button of the cutting means was mounted on the surface of the case body, and the trigger of the drawing means was provided away from the operating button, it could be inconvenient to operate the drawing means and the cutting means with rapidity.

Technical Solution

In order to overcome the above disadvantages of the conventional tape dispenser, the present invention provides an improved adhesive tape dispenser including a drawing trigger and a cutting lever provided close to each other and pulled by a user's finger, so that the convenience of users can greatly be enhanced.

Further, the present invention provides an improved tape dispenser which can contain an adhesive tape with various width therein, so that when the adhesive tape is used up and needs to be replaced, a new adhesive tape can be narrower or wider in width than the old one.

Furthermore, the present invention provides an tape dispenser, parts of which can simply be assembled and which can be applied to both one-faced and double-faced adhesive tapes, so that the manufacturing efficiency and economy can be increased.

Advantageous Effects

According to the present invention, as the drawing trigger and the cutting lever are provided close to each other to be pulled by a user's finger, the convenience in using the tape dispenser can considerably be improved.

According to the present invention, as the parts of the tape dispenser can be assembled simply and easily, manufacturing costs can be reduced, while the efficiency can be improved.

Further, since the tape dispenser according to the present invention can contain an adhesive tape with various width therein, when the adhesive tape is used up and needs to be replaced, a new adhesive tape can be narrower or wider in width than the old one.

Therefore, according to the present invention, the reliability and convenience of the tape dispenser can be improved.

### BRIEF DESCRIPTION OF THE DRAWINGS

FIG. 1 is a front sectional view of a tape dispenser of the present invention, wherein a drawing means and a cutting means are provided in a case body.

FIG. 2 is an exploded perspective view of the drawing means of the tape dispenser according to the present invention.

FIGS. 3 and 4 are partial sectional views showing operating states of the drawing means.

FIG. 5 is a partial sectional rear view of the drawing means provided with a reverse control means on one side thereof.

FIG. 6 is an exploded perspective view of the cutting means of the tape dispenser according to the present invention.

FIG. 7 is a partial sectional front view of the tape dispenser showing a state where the cutting means is installed.

FIG. 8 is a partial sectional front view of the tape dispenser showing a state where a pressing part is lowered by the operation of the cutting means.

FIG. 9 is a partial sectional front view of the tape dispenser showing a state where an adhesive tape is cut by a cutter of the cutting means.

### BEST MODE FOR CARRYING OUT THE INVENTION

In order to achieve the above objects of the present invention, an adhesive tape dispenser comprises: a case body (10) in a gun shape containing an adhesive tape (20) therein;

a drawing means (50) including a trigger (15) protruded out of the case body (10) and a pair of drums (16) rotated by pulling the trigger (15) and rotating in contact with a bottom surface of the adhesive tape (20) to draw out the adhesive tape (20);

a cutting means (300) including a cutting lever (31) provided adjacent to the trigger (15) outside of the case body (10), a lever (32) operated by pulling the cutting lever (31), and a cutter (30) provided at a front end of the lever (32) and lowered to cut the adhesive tape (20) which has been drawn out by the drawing means (50); and

a reverse control means (400) to prevent a backlash of the drums (16) in operating the drawing means (50).

More specifically, the cutting means (300) comprises: the cutting lever (31) provided outside of the case body (10); a driving rod (31a) connected to the cutting lever (31); a middle plate (37) hung on the driving rod (31a); a movable latch (73) having an extension (74) placed over the middle plate (37) and a support (36); a lever (32) in a rectangular form having one end supported by the support (36) and including hinge pins (95) on which the lever (32) axially rotates and protrusions (80) formed at the other end of the lever (32); a cutter (30) movable up and down by the lever (32) and having holes (81) to which the protrusions (80) are fitted; a pressing part (34) lowered to press and support the adhesive tape (20) and having guiding pieces (35) integrally extended therefrom in the form of a clip to move up and down the cutter (30) fitted in the clip; and a pair of elastic plates (82), each of which including a jaw (82b) on which the pressing part (34) hangs and a supporting extension (82c) in the form of a thin panel to elastically press and support a top surface of the lever (32).

Therefore, as described above, since the trigger (15) is positioned in the vicinity of the cutting lever (31) outside of the case body (10), drawing and cutting operations of the adhesive tape (20) can be done smoothly with easiness and rapidity.

Further, the tape dispenser of the present invention includes the drums (16) and the cutting means (300), which are wide enough to cover adhesive tapes with various width.

Therefore, the availability and applicability of the tape dispenser of the present invention can greatly be increased.

Mode for the Invention

The preferred embodiments of the present invention will be described in detail with reference to the accompanying drawings.

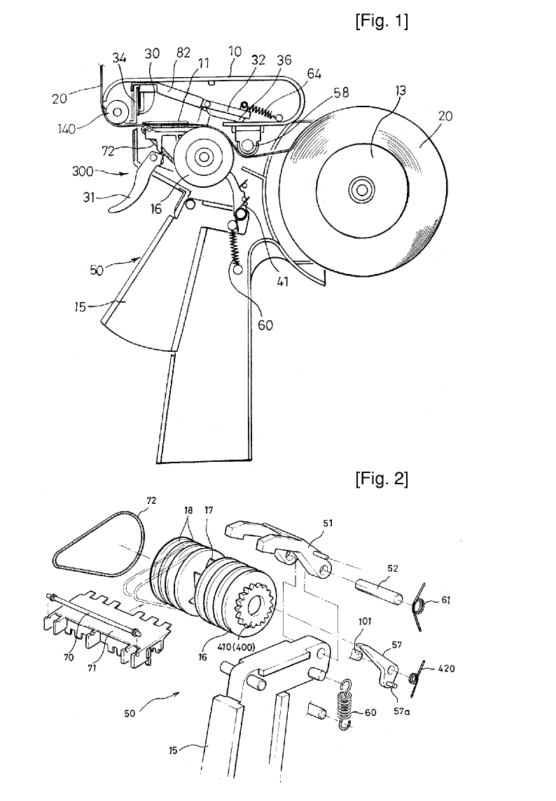

FIG. 1 shows that the drawing means (50) and the cutting means (300) are provided in the case body (10).

FIG. 2 shows an exploded perspective view of the drawing means (50).

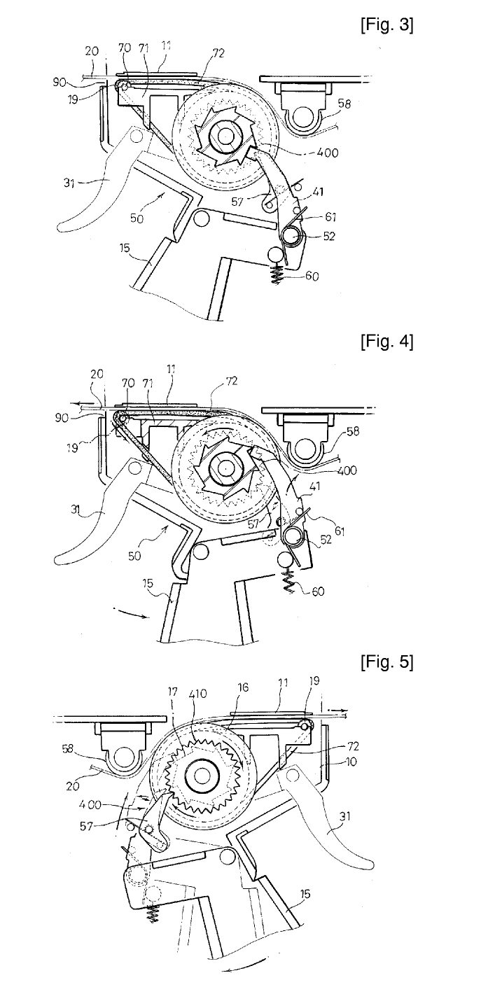

FIGS. 3 and 4 respectively show the procedures in which the drums (16) are driven by the operation of the trigger (15) to withdraw the adhesive tape (20).

FIG. 5 shows partially a sectional rear view of the drawing means (50) provided with the reverse control means (400) on a rear side thereof.

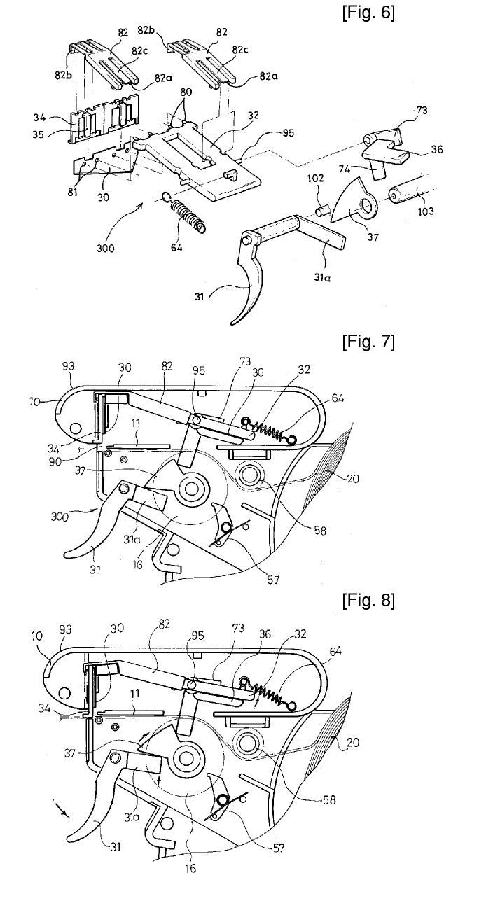

FIG. 6 shows an exploded perspective view of the cutting means (300).

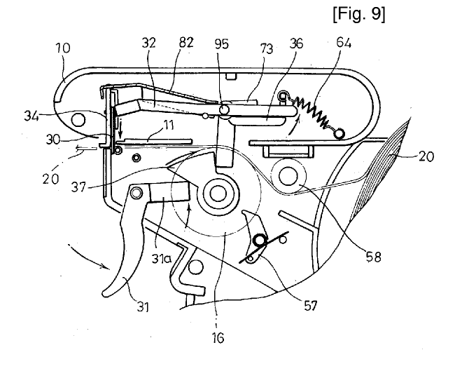

FIGS. 7 to 9 show the states where the pressing part (34) and the cutter (30) of the cutting means (300) are lowered to cut the adhesive tape (20).

In the present invention, the case body (10) may be provided in duplicate. That is, a pair of case bodies may be positioned side by side.

The adhesive tape (20) is wound on a bobbin having a perforated central part, and is detachably fitted to a holding means (13) through the perforated central part.

Outside of the case body (10), the trigger (15) comes out, and the cutting lever (31) is provided in front of the trigger (15). The trigger (15) and the cutting lever (31) can be separately pulled with a finger of a user to drive the drawing means (50) and the cutting means (300) respectively.

The drawing means (50) includes a pair of drums (16) rotated by pulling the trigger (15). The drums (16) rotate in contact with a bottom surface of the adhesive tape (20), of which the bottom surface or both surfaces are lined with an adhesive, so that the adhesive tape (20) can be drawn out.

The drawing means (50) is provided in front of the holding means (13).

The trigger (15) is fitted with a push latch (51) through a shaft pin (52) so that the trigger (15) can rotate with an axis of the shaft pin (52). The push latch (51) is elastically supported by a second spring (61), and one end of the push latch (51) leans on one side of ratchets (17) formed in serial in the middle of the drums (16).

The trigger (15) is elastically supported by a first spring (60) with the case body (10), so that the trigger (15) remains on standby just before being pulled.

A guide rod (58) may be provided on a location between the drums (16) and the holding means (13), so that the adhesive surface of the tape (20) can smoothly come into contact with an external surface of the drums (16).

The reverse control means (400) is provided on one side of the drums (16).

Back ratchets (410) are integrally formed on one side surface or both side surfaces of the drums (16) and a support latch (57) is elastically supported by a spring (420), so that the support latch (57) can be engaged with the back ratchets (410). Therefore, when the trigger (15) is operated, it enables the drums (16) to rotate in a withdrawing direction of the adhesive tape (20), and when the trigger (15) is released, the push latch (51) moves together to release the engagement with the ratchets (17) temporarily.

In this case, as the support latch (57) is always engaged with the back ratchets (410) by the elasticity of the spring (420), it can prevent the backlash of the drums (16) even when the rotational force of the drums (16) has been released.

The support latch (57) is axially mounted on the case body (10) centering around a pivot axis (101), and the spring (420) is elastically supported between the case body (10) and a pin (57a) of the support latch (57).

Therefore, the support latch (57) can prevent the backlash of the drums (16) irrespective of the movement of the trigger (15) and the push latch (51).

The drums (16) are provided with the ratchets (17) along an internal circumference thereof and provided with belt grooves (18) along external peripheries thereof on both sides of the ratchets (17).

Further, a pair of auxiliary rollers (19) are axially mounted on both ends of a shaft (70), which is maintained at a predetermined distance from the drums (16) by an interval maintaining means (71). As the shaft (70) and the drums (16) are connected by a belt (72), rotation of the drums (16) causes the auxiliary rollers (19) to rotate.

It is preferable that the auxiliary rollers (19) are formed to have external surfaces in a gear shape to minimize a contact area with the adhesive surface of the tape (20). With the auxiliary rollers (19) configured as such, the adhesive tape (20) can be withdrawn smoothly.

The gear form of the auxiliary rollers (19), rather than a circular form, enables the rollers (19) to have a linear contact with the adhesive tape (20), not a surface contact, so that the adhesive tape (20) can be smoothly drawn out.

The cutting means (300) is provided at a front end of the case body (10). Besides the cutting lever (31) provided outside of the case body (10), the cutting means (300) comprises the lever (32), a rear end of which is elastically supported by a third spring (64) and a front end of which is provided with protrusions (80) to be connected with the cutter (30). The lever (32) axially rotates with the axis of the hinge pins (95).

The cutting lever (31) is integrally connected to the driving rod (31a), which moves the middle plate (37), which in turn moves the movable latch (73), the lever (32), the elastic plates (82) and the pressing part (34).

The pressing part (34) is lowered to press and support the adhesive tape (20) and has guiding pieces (35) integrally extended therefrom in the form of a clip to move up and down the cutter (30) fitted in the clip.

The elastic plates (82) have elasticity in itself and are provided between the lever (32) and the pressing part (34).

Each of the elastic plates (82) is made of synthetic resin material, and includes the jaw (82b) at a front end thereof to force on the pressing part (34), fitting jaws (82a) at a rear end thereof to be fitted with grooves formed on the lever (32), and the supporting extension (82c) in the form of a thin panel to elastically press and support a top surface of the lever (32).

The pressing part (34) descends on the adhesive tape (20) before the cutter (30) comes in contact with the tape (20) and presses to fix the tape (20), so that the cutter (30) can cut later with more stability and accuracy.

When the adhesive tape (20) has been withdrawn with a desired length, the cutting lever (31) is pulled with a finger of a user, and the driving rod (31a) integrally connected to the cutting lever (31) moves the middle plate (37), which in turn moves the movable latch (73).

Then, the support (36) of the movable latch (73), which has been put over the middle plate (37), moves up a rear part of the lever (32), and then the lever (32) rotates to move the pressing part (34) and the cutter (30) in sequence.

The movable latch (73) is fitted to one of the hinge pins (95) and it moves pivotably centering around the hinge pin (95).

The middle plate (37) is pivotably provided on a pin (103), which is protruded from the case body (10).

Further, the driving rod (31a) is integrally connected to the cutting lever (31) and is pivotably mounted on the pivot axis (102), which is protruded from the case body (10).

The pressing part (34) is elastically supported by the elastic plates (82).

Thus, the pressing part (34) descends earlier than the cutter (30) to press and fix the adhesive tape (20) temporarily.

An end corner (93) of the case body (10) is formed by smoothly curving a front end part of the case body (10). Right inside the end comer (93), the cutting means (500) are provided.

Meanwhile, as shown in FIGS. 7-9, a guide plate (11) may be provided over the drums (16) in order to maintain tension on the adhesive tape (20) while the tape (20) is being drawn out.

With the structure described above, the tape dispenser of the present invention is held with one hand of a user, and a finger of the user is put on the trigger (15). When the trigger (15) is pulled with the finger once or several times, the adhesive tape (20) is withdrawn as long as necessary, without having to pull out the adhesive tape (20) directly with the hand.

Then, when the cutting lever (31) is pulled with a finger, the cutter (30) descends to cut off the adhesive tape (20) which has been withdrawn outside of the tape dispenser.

Further, a discharge roller (140) may be provided at a front end of the case body (10) to smoothly draw out the adhesive tape (20).

The discharge roller (140) guides the adhesive tape (20), which is lined with an adhesive on one side or on both sides and has been moved forward through the drawing means (50), to advance forward more smoothly.

1. An adhesive tape dispenser comprising a case body in a gun shape containing an adhesive tape therein;
a drawing means including a trigger protruded out of the case body and a pair of drums rotated by pulling the trigger and rotating in contact with a bottom surface of the adhesive tape to draw out the adhesive tape;
a cutting means including a cutting lever provided adjacent to the trigger outside of the case body, a lever operated by pulling the cutting lever, and a cutter provided at a front end of the lever and lowered to cut the adhesive tape which has been drawn out by the drawing means; and
a reverse control means to prevent a backlash of the drums in operating the drawing means.

2. An adhesive tape dispenser as claimed in claim 1, wherein the reverse control means comprises back ratchets integrally formed on one side surface or both side surfaces of the drums and a support latch elastically supported by a spring, with the support latch being engaged with the back ratchets.

3. An adhesive tape dispenser as claimed in claim 1, wherein the cutting means comprises the cutting lever provided outside of the case body; a driving rod connected to the cutting lever; a middle plate hung on the driving rod; a movable latch having an extension placed over the middle plate and a support; the lever in a rectangular form having one end supported by the support and including hinge pins on which the lever axially rotates and protrusions formed at the other end of the lever; the cutter movable up and down by the lever and having holes to which the protrusions are fitted; a pressing part lowered to press and support the adhesive tape and having guiding pieces integrally extended therefrom in the form of a clip to move up and down the cutter fitted in the clip; and a pair of elastic plates provided between the lever and the pressing part to elastically press and support a top surface of the lever.

4. An adhesive tape dispenser as claimed in claim 3, wherein each of the elastic plates is made of synthetic resin material, and includes a jaw at a front end thereof to force on the pressing part, fitting jaws at a rear end thereof to be fitted with grooves formed on the lever, and a supporting extension in the form of a thin panel to elastically press and support a top surface of the lever.
